(19) United States
(12) Patent Application Publication
(10) Pub. No.: US 2011/0074343 A1
(43) Pub. Date: Mar. 31, 2011

(54) WIRELESS COMMUNICATION MODULE

(75) Inventor: Peng Sen Chen, Shinchu City (TW)

(73) Assignee: ISSC TECHNOLOGIES CORP., Shinchu City (TW)

(21) Appl. No.: 12/887,215

(22) Filed: Sep. 21, 2010

Related U.S. Application Data
(60) Provisional application No. 61/247,055, filed on Sep. 30, 2009.

(51) Int. Cl. H02J 7/00

(52) U.S. Cl. 320/108

(57) ABSTRACT

A wireless communication module includes a radiation unit, a battery, and a communication unit. The radiation unit has an antenna and a rectifier, in which the antenna is used to receive a radio frequency (RF) signal, and the rectifier converts the RF signal and outputs a voltage signal. The battery receives the voltage signal, and accordingly stores an electrical energy. The communication unit is electrically connected to the battery, and is powered by the electrical energy. When the wireless communication module is applied to a communication device, the RF signal is used as a source of an electrical power, and as the radiation unit and the communication unit are integrated into a system on chip (SOC), an overall volume of the communication device is effectively reduced.

### CROSS-REFERENCE TO RELATED APPLICATIONS

This non-provisional application claims priority under 35 U.S.C. §119(e) on Patent Application No. 61/247,055 filed in the United States on Sep. 30, 2009, the entire contents of which are hereby incorporated by reference.

### BACKGROUND OF THE INVENTION

1. Field of the Invention

The present invention relates to a wireless communication module, and more particularly, to a wireless communication module having a radiation unit, so as to rectify and convert an radio frequency (RF) signal to an electrical energy required by execution of a communication unit.

2. Related Art

Along with the ever changing technology, due to the portable convenience, the cell phone gradually becomes an indispensable part in the life of modern people, and the popularization of the cell phone is also quickly expanded. During operations, when the cell phone receives messages, sends messages, performs displaying, and functions as a loudspeaker, a power source is required by the cell phone to perform functions above. Here, according to different charging capacities, a battery installed in the cell phone needs to be replaced after certain using time, or the cell phone has to be directly charged, so as to refill the electrical power and continue the operation time of the cell phone.

A conventional cell phone charger is externally connected to a household alternating current (AC) power source through a power source line, so as to rectify the household AC power source to a direct current (DC) power source, and charge the cell phone or the battery. As the using amount of the cell phone and the using amount of the power source are rapidly increased, the charging manner wastes the global energy sources. In addition, due to the winding and the twisting of the power source line, the conventional charger has problems of large portable volume when being taken out, and inconveniences for the user.

Besides, after the cell phone is used for a long time, and the lifetime is getting short, the power consumption of the cell phone also gradually becomes higher. Under this situation, if the cell phone is used to execute programs requiring higher operation quantity (for example, web page browsing, real-time e-mail receiving and sending, or video and audio program playing), the electrical power of the battery of the cell phone may be exhausted in quite a short time. Thus, the user needs to continuously and repeatedly perform the charging action, so as to resume the electrical power of the battery, therefore additionally resulting in troubles and inconveniences for the user during operation.

### SUMMARY OF THE INVENTION

In view of the above, the present invention is a wireless communication module, applicable to a cell phone, a notebook computer, a multi-media player (Ipod), or other communication devices. In the wireless communication module according to the present invention, an RF signal received by a radiation unit may be rectified and converted, so as to charge the communication device, and an overall volume of the communication device is effectively reduced, thus achieving the portability obtained after the radiation unit is effectively integrated into the communication device.

The present invention provides a wireless communication module, which comprises a radiation unit, a battery, and a communication unit. The radiation unit has an antenna and a rectifier, in which the antenna is used to receive an RF signal, and the rectifier converts the RF signal, and accordingly outputs a voltage signal. The battery receives the voltage signal, and accordingly stores an electrical energy. The communication unit is electrically connected to the battery, and is powered by the electrical energy.

In the wireless communication module according to the present invention, the communication unit and the radiation unit are integrated into a system on chip (SOC).

The wireless communication module according to the present invention further comprises a charging unit, for supplying a DC power source to the battery or the communication unit.

In the wireless communication module according to the present invention, a switch is disposed between the communication unit, the charging unit, and the battery, and the communication unit is selectively switched to either a first conduction path or a second conduction path.

Therefore, in the wireless communication module according to the present invention, the radiation unit rectifies and converts the RF signal to the electrical energy stored in the battery, for serving as the source of the electrical power of the communication unit. Besides, in the wireless communication module according to the present invention, the DC power source may be selectively directly supplied to the communication unit by the charging unit. Therefore, when the wireless communication module according to the present invention is applied to the communication device, the consumption of the energy source is effectively reduced, and the overall volume of the communication device is saved.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a wireless communication module according to a first embodiment of the present invention;

FIG. 2A to 2C are functional block diagrams of a wireless communication module according to a second embodiment of the present invention;

FIG. 3 is a functional block diagram of a wireless communication module according to a third embodiment of the present invention;

FIGS. 4A and 4B are respectively schematic inside views of a current stabilizing element according to an embodiment of the present invention;

FIG. 5 is a functional block diagram of a wireless communication module according to a fourth embodiment of the present invention; and

FIG. 6 is a functional block diagram of a wireless communication module according to a fifth embodiment of the present invention.

### DETAILED DESCRIPTION OF THE INVENTION

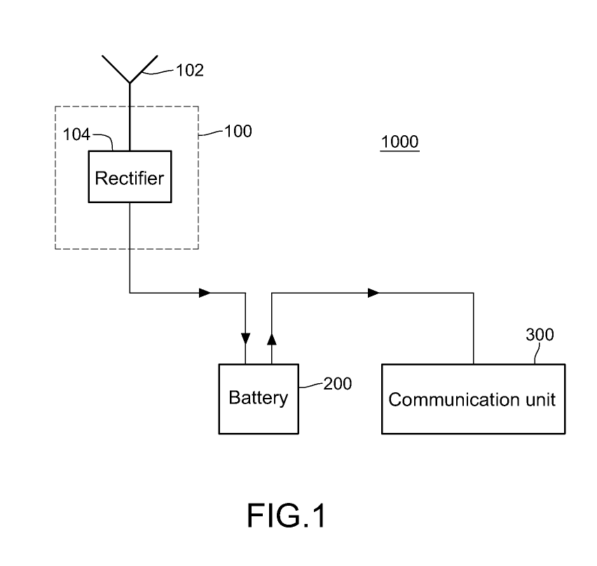

FIG. 1 is a functional block diagram of a wireless communication module according to a first embodiment of the present invention. In the description in the following, the wireless communication module is applied to a cell phone, for serving as the description of an embodiment of the present invention. However, the wireless communication module according to the embodiment of the present invention may be further applied to a personal digital assistant (PDA), a notebook computer, a multi-media player (iPod), or other communication devices, in which types of the communication devices are not used to limit the scope of the present invention.

As shown in FIG. 1, the wireless communication module 1000 comprises a radiation unit 100, a battery 200, and a communication unit 300. The radiation unit 100 has an antenna 102 and a rectifier 104. The antenna 102 is used to receive an RF signal, and the rectifier 104 converts the RF signal received by the antenna 102, accordingly rectifies the RF signal, and outputs a voltage signal. The antenna 102 may be a monopole antenna, a dipole antenna, a planar antenna, or an inverted F antenna. The battery 200 is electrically connected to the radiation unit 100, and is used to receive the voltage signal output by the rectifier 104, and convert the voltage signal to an electrical energy stored in the battery 200. The communication unit 300 is electrically connected to the battery 200, and is powered by the electrical energy stored in the battery 200, in which the communication unit 300 may be blue tooth (BT), wireless fidelity (Wi-Fi), or other wireless communication integrated circuit chips (ICs).

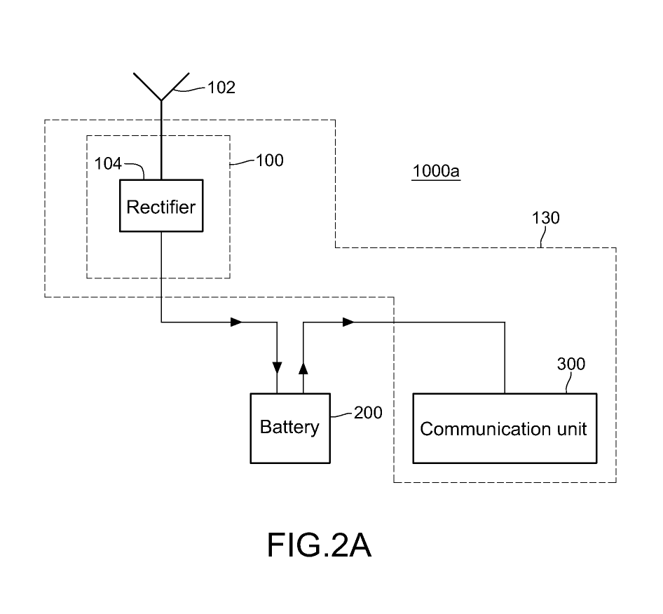

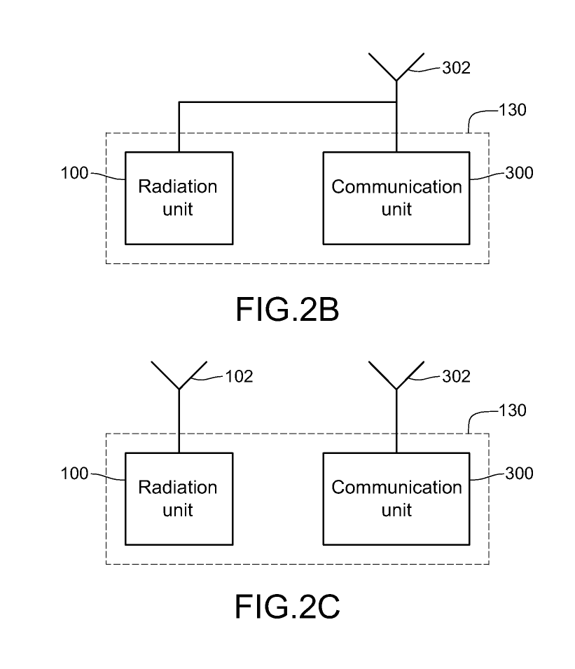

In order to save the overall volume of the communication device (for example, the cell phone), as shown in FIG. 2A, a functional block diagram of the wireless communication module according to a second embodiment of the present invention, the radiation unit 100 and the communication unit 300 of the wireless communication module 1000a are selectively integrated into an SOC 130, so as to effectively integrate a system and reduce the overall volume of the communication device without affecting the communication function.

Referring to FIGS. 2B and 2C, when the radiation unit 100 and the communication unit 300 are integrated into the SOC 130, the antenna 102 of the radiation unit 100 may be selectively shared with an antenna 302 of the communication unit 300. For example, according to the second embodiment of the present invention, if the antenna 102 of the radiation unit 100 is used to receive a band signal suitable for the cell phone (for example, a frequency is 900 or 1800 MHz), as shown in FIG. 2C, the antenna 102 of the radiation unit 100 may be disposed separately from the antenna 302 of the communication unit 300. If the antenna 102 of the radiation unit 100 is used to receive an Industrial Scientific and Medical Band (ISM Band) signal (for example, a frequency is 2.4 GHz), as shown in FIG. 2B, the antenna 102 of the radiation unit 100 is shared with the antenna 302 of the communication unit 300, so as to save the cost of additionally fabricating the antenna of the radiation unit 100.

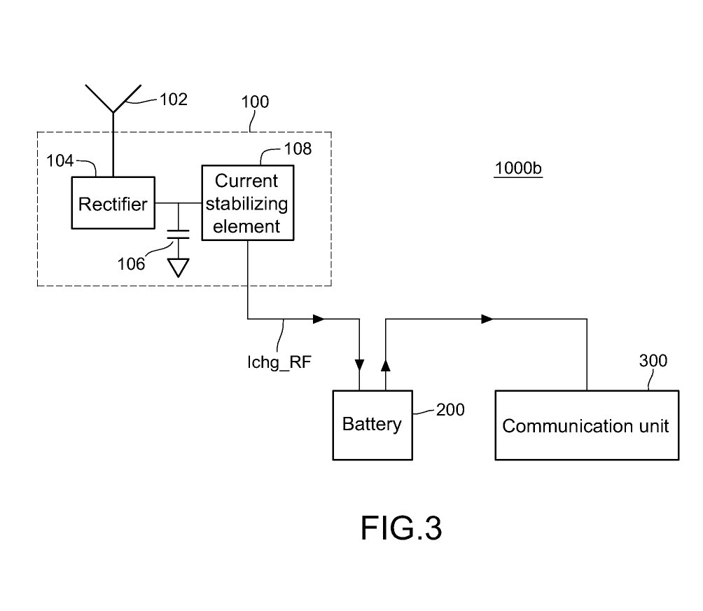

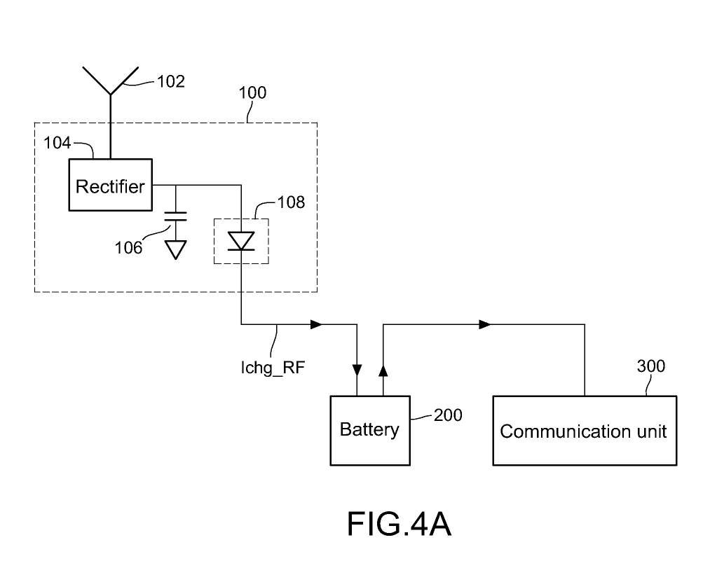

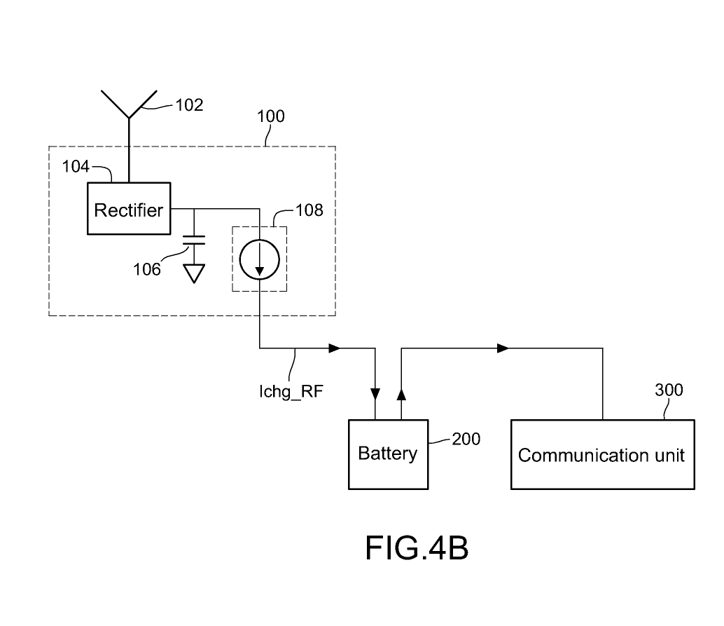

FIG. 3 is a functional block diagram of the wireless communication module according to a third embodiment of the present invention. The radiation unit 100a of the wireless communication module 1000b further comprises a capacitor 106 and a current stabilizing element 108. The capacitor 106 is connected in parallel with the rectifier 104, and is used to store the voltage signal output by the rectifier 104. The current stabilizing element 108 is electrically connected between the capacitor 106 and the battery 200, and the current stabilizing element 108 converts the voltage signal stored by the capacitor 106 to a relatively stable current source, so as to supply a constant current Ichg_RF, for the battery 200 to store therein. FIGS. 4A and 4B are respectively schematic inside views of the current stabilizing element according to an embodiment of the present invention, in which the current stabilizing element 108 may be a diode as shown in FIG. 4A, or a current source in FIG. 4B.

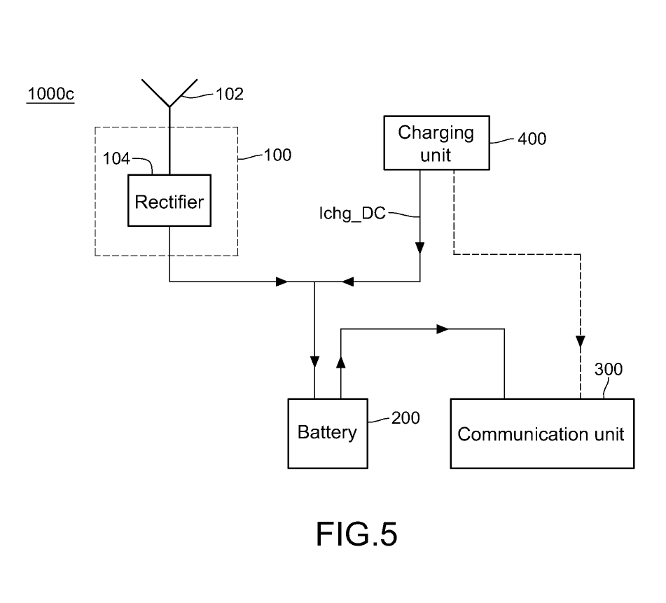

FIG. 5 is a functional block diagram of the wireless communication module according to a fourth embodiment of the present invention. In addition to the radiation unit 100, the battery 200, and the communication unit 300, the wireless communication module 1000c further comprises a charging unit 400, which supplies a DC power source Ichg_DC to the battery 200 or the communication unit 300. That is to say, the DC power source Ichg_DC is not only used to charge the battery 200, so as to serve as a source of an electrical power of the communication unit 300, but also directly supplies the electrical power to the communication unit 300.

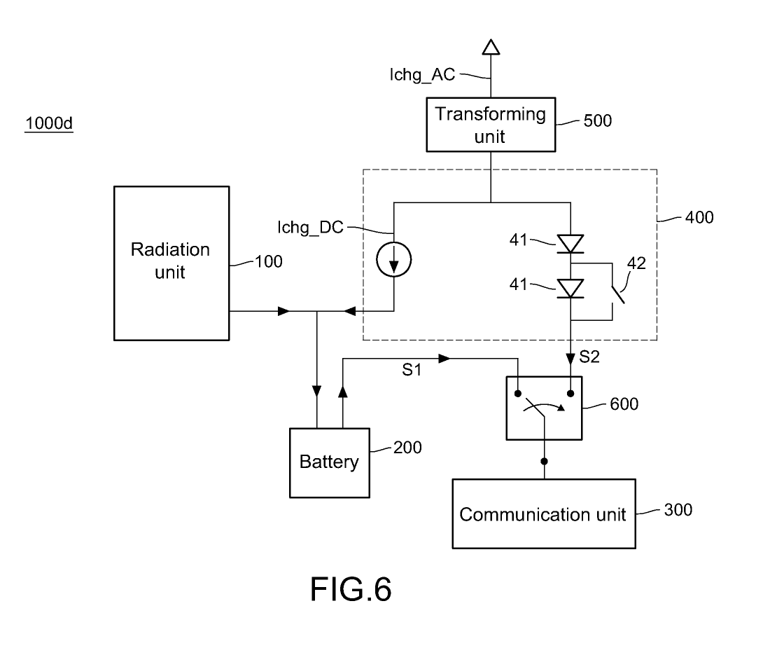

Accordingly, refers to FIG. 6, a functional block diagram of the wireless communication module according to a fifth embodiment of the present invention. A switch 600 is disposed between the communication unit 300, the charging unit 400, and the battery 200, and the communication unit 300 is selectively switched to either a first conduction path S1 or a second conduction path S2. When the switch 600 is switched to the first conduction path S1, the battery 200 is electrically conducted to the communication unit 300, so as to supply the electrical power to the communication unit 300 for executing its communication function. Here, the electrical power supplied by the battery 200 may comprise the electrical energy converted by the radiation unit 100, and the DC power source Ichg_DC supplied by the charging unit 400.

When the switch 600 is switched to the second conduction path S2, that is, the charging unit 400 is electrically conducted to the communication unit 300, and supplies the electrical power to the communication unit 300 for executing its communication function. Here, the DC power source Ichg_DC supplied by the charging unit 400 may be adjusted according to continuous flow diodes 41 and a switching unit 42, and is directly input to the communication unit 300, for supplying the source of the electrical energy required by operation of the communication unit 300.

As shown in FIG. 6, the charging unit 400 is further connected to a transforming unit 500, in which the transforming unit 500 may be, but not limited to, a transformer, a linear converter, or a switch converter. The transforming unit 500 receives an AC power source Ichg_AC, and converts the AC power source Ichg_AC to the DC power source Ichg_DC subsequently output to the charging unit 400. Therefore, according to the fifth embodiment of the present invention, the wireless communication module 1000d may also be applied to a household AC power source, and after being rectified and converted by the transforming unit 500, the AC power source is then turned into the DC power source supplied to the operation of the communication unit 300.

To sum up, in the wireless communication module according to the first embodiment of the present invention, the antenna of the radiation unit receives the RF signal, and the rectifier converts the RF signal and accordingly outputs the voltage signal. Then, the battery receives the voltage signal and stores the electrical energy, such that the electrical energy serves as the source of the electrical power of the operation of the communication unit. Next, according to the fourth embodiment of the present invention, in order to increase the electrical energy stored by the battery, the wireless communication module further has a charging unit, so as to supply the additional DC power source, for being stored by the battery or being directly supplied to the communication unit. Therefore, when the wireless communication module according to the embodiment of the present invention is applied to the communication device, the consumption of the energy source is saved, and as the communication unit and the radiation unit are integrated into the SOC (the second embodiment), the overall volume of the communication device when being fabricated is reduced.

What is claimed is:

1. A wireless communication module, comprising:
a radiation unit, having an antenna and a rectifier, wherein the antenna is used to receive a radio frequency (RF) signal, the rectifier converts the RF signal, and accordingly outputs a voltage signal;
a battery, for receiving the voltage signal, and accordingly storing an electrical energy; and
a communication unit, electrically connected to the battery, and powered by the electrical energy.

2. The wireless communication module according to claim 1, wherein the communication unit and the radiation unit are integrated into a system on chip (SOC).

3. The wireless communication module according to claim 1, further comprising a charging unit, for supplying a direct current (DC) power source to the battery or the communication unit.

4. The wireless communication module according to claim 3, wherein the charging unit is further connected to a transforming unit, and the transforming unit converts an alternating current (AC) power source to the DC power source.

5. The wireless communication module according to claim 3, wherein a switch is disposed between the communication unit, the charging unit, and the battery, and the communication unit is selectively switched to either a first conduction path or a second conduction path.

6. The wireless communication module according to claim 5, wherein the battery is electrically conducted to the communication unit through the first conduction path, such that the communication unit executes a communication function.

7. The wireless communication module according to claim 5, wherein the charging unit is electrically conducted to the communication unit through the second conduction path, such that the communication unit executes a communication function.

8. The wireless communication module according to claim 1, wherein the radiation unit further comprises a capacitor, connected in parallel with the rectifier, for storing the voltage signal.

9. The wireless communication module according to claim 8, wherein the radiation unit further comprises a current stabilizing element, electrically connected between the capacitor and the battery, for supplying a constant current to the battery.

10. The wireless communication module according to claim 9, wherein the current stabilizing element is a diode.

11. The wireless communication module according to claim 9, wherein the current stabilizing element is a current source.

12. The wireless communication module according to claim 1, wherein the antenna of the radiation unit is used to receive a cellular band signal with frequency of 900 or 1800 MHz.

13. The wireless communication module according to claim 1, wherein the antenna of the radiation unit is used to receive an Industrial Scientific and Medical Band (ISM Band) signal with frequency of 2.4 GHz.
